(19) United States
(12) Patent Application Publication
(10) Pub. No.: US 2022/0087210 A1
(43) Pub. Date: Mar. 24, 2022

(54) ENCAPSULATED LITTER BOX

(71) Applicant: JOSE FEDERICO RODRIGUEZ, AVON, IN (US)

(72) Inventor: JOSE FEDERICO RODRIGUEZ, AVON, IN (US)

(21) Appl. No.: 17/339,124

(22) Filed: Jun. 4, 2021

Related U.S. Application Data
(60) Provisional application No. 63/081,324, filed on Sep. 22, 2020.

(51) Int. Cl. A01K 1/01

(52) U.S. Cl. CPC A01K 1/0107

(57) ABSTRACT

An encapsulated pet litter box mountable to a wall, or free-standing, has a housing assembly with a removable bottom portion, at least one two sidewall portions, and a removable top portion assembly. At least one lid member of the top portion assembly is pivotally coupled to the top portion assembly and designed to be opened or closed. An enclosed tunnel assembly with an open distal and proximal end is coupled to the at least one sidewall portion by the distal end of the tunnel assembly, the tunnel assembly extending from the sidewall portion and defining a proximal end of the housing assembly. The tunnel assembly is designed to be disposed through the wall structure of the housing assembly. A flap assembly is pivotally coupled to a top portion of the proximal end of the enclosed tunnel assembly, the flap assembly designed, when in a resting state, to substantially cover the open proximal end of the tunnel assembly.

### CLAIM OF PRIORITY

This application claims priority to and the benefit of U.S. Provisional application with Ser. No. 63/081,324, filed on Sep. 22, 2020, with the same title, which is incorporated herein by reference in its entirety.

### FIELD OF THE INVENTION

The inventive concept relates generally to an encapsulated litter box.

### BACKGROUND

Currently, there are a number of solutions for litter boxes. One of these solutions attempts to utilize an automatic litter box, but this solution fails to meet the needs of the market because automatic litterboxes are expensive, subject to product failure to the moving parts and are not always odor-proof as claimed during prolonged use. Another solution attempts to utilize standard litter boxes, but this solution is similarly unable to meet the needs of the market because standard litter boxes do not lock in odors well. Still another solution seeks to use pet pads, but this solution also fails to meet market needs because pet pads are messy and get expensive if you dispose of them after a single use. Therefore, there currently exists a need in the market for a pet litter box system that is cost competitive, contains pet waste odor and may be located anywhere or may even be mountable to a wall away from pet owners and food areas.

### SUMMARY OF THE INVENTION

The inventive concept is an encapsulated cat (or any other pet) litter box mountable to a wall (or free standing) that has a housing assembly with a removable bottom portion, at least one sidewall portion, and a removable top portion assembly, at least one lid member of the top portion assembly pivotally coupled to the top portion assembly designed to be in a substantially open or closed state. An enclosed tunnel assembly with an open distal end and an open proximal end, the tunnel assembly coupled to the at least one sidewall portion by the distal end of the tunnel assembly, the tunnel assembly extending from the at least one sidewall portion, defines a proximal end of the housing assembly and front face of the housing assembly. The tunnel assembly is designed to be disposed through the wall structure. A flap assembly is pivotally coupled to a top portion of the proximal end of the enclosed tunnel assembly, the flap assembly designed, when in a resting state, to substantially cover the open proximal end of the enclosed tunnel assembly.

In one embodiment of the encapsulated cat litter box mountable to a wall, at least one window portion is disposed within the at least one sidewall portion and configured to allow viewing therethrough by pets or people.

In one embodiment of the encapsulated cat litter box mountable to a wall, at least one vent portion designed to allow air therethrough is disposed within the at least one sidewall portion.

In one embodiment of the encapsulated cat litter box mountable to a wall, a bottom portion removable inner floor portion and a tunnel assembly removable inner floor portion are planarly and respectively disposed to cover a top surface of the bottom portion of the housing assembly and a top surface of a floor portion of the tunnel assembly. Optionally, the inner floor portion of the main housing need not be removable so as to form a unitary housing, such as a molded housing for ease of manufacturing and lowering of cost.

In one embodiment of the encapsulated cat litter box mountable to a wall, a wall attachment assembly is coupled to the proximal end of the housing assembly and designed to removably couple the housing assembly to the wall.

In one embodiment of the encapsulated cat litter box mountable to a wall, one or more extendable leg assemblies are coupled to the removable bottom portion of the housing assembly.

A litter box, sometimes called a sandbox, cat box, litter tray, cat pan, or litter pan, is an indoor feces and urine collection box for cats, as well as rabbits, ferrets, miniature pigs, small dogs (such as Beagles and Chihuahuas), and other pets that instinctively or through training will make use of such a repository. They are provided for pets that are permitted free roam of a home but who cannot or do not always go outside to excrete their metabolic waste. Many owners of these animals prefer not to let them roam outside for fear that they might succumb to outdoor dangers.

It would be advantageous to have an encapsulating cat litter box mountable to a wall that is enclosed. Furthermore, it would also be advantageous to have an encapsulating cat litter box mountable to a wall that is reusable. Still further, it would be advantageous to have an encapsulating cat litter box mountable to a wall that is adjustable.

The inventive concept advantageously fills the aforementioned deficiencies by providing an encapsulated litter box, which provides a litter box that traps odors. The encapsulated cat litter box mountable to a wall has a viewing window. The encapsulated cat litter box mountable to a wall may have telescoping legs. The encapsulated cat litter box mountable to a wall fulfills the need for an odor locking litter box.

Among other things, it is an advantage of the inventive concept to provide an encapsulated litter box that does not suffer from problems or deficiencies associated with prior solutions. It is still further an advantage of the inventive concept to be installable. Still further, the encapsulated cat litter box mountable to a wall may have wall mounts.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a left side view of an encapsulated pet litter box mountable to and through a wall.

FIG. 2 illustrates a bottom view of the encapsulated pet litter box mountable to a wall.

FIG. 3 illustrates a top view of the encapsulated pet litter box mountable to a wall.

FIG. 4 illustrates a front view of the encapsulated pet litter box mountable to a wall.

FIG. 5 illustrates a rear view of the encapsulated pet litter box mountable to a wall.

FIG. 6 illustrates a right side view of the encapsulated pet litter box mountable to a wall.

FIG. 7 illustrates a perspective view of the encapsulated pet litter box mountable to a wall.

FIG. 8 illustrates an elevated perspective view of the encapsulated pet litter box mountable to a wall.

FIG. 9 illustrates an exploded view of the encapsulated pet litter box mountable to a wall.

FIG. 10 illustrates a wall attachment assembly accessory disposed on the litter box housing.

FIG. 11A-11B illustrates a method for installing and using the encapsulated pet litter box mountable to a wall.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

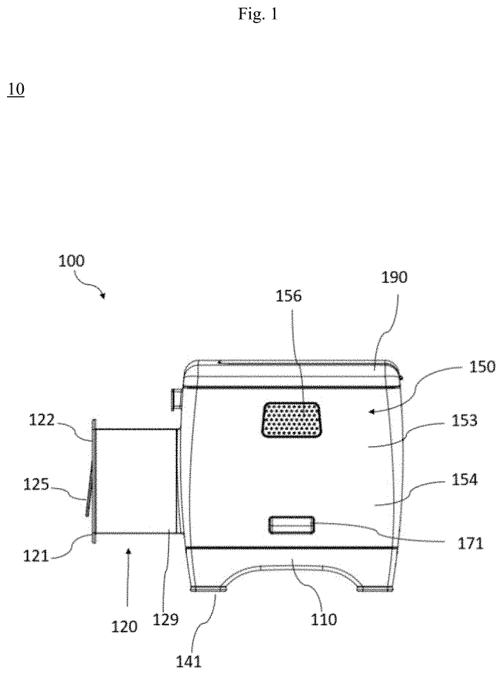

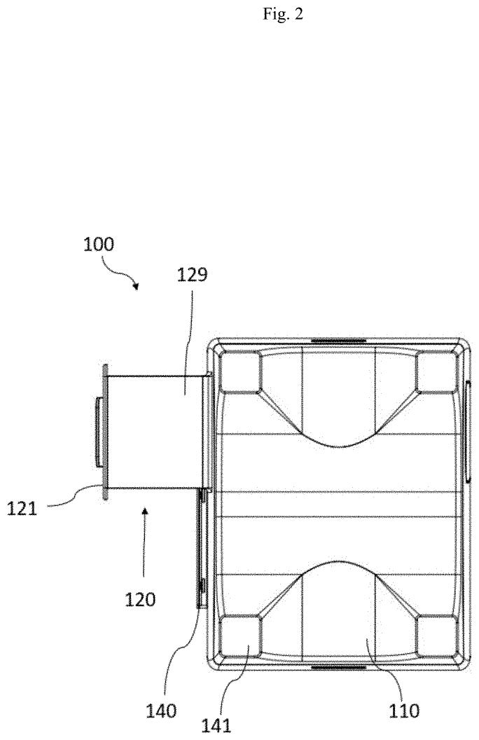

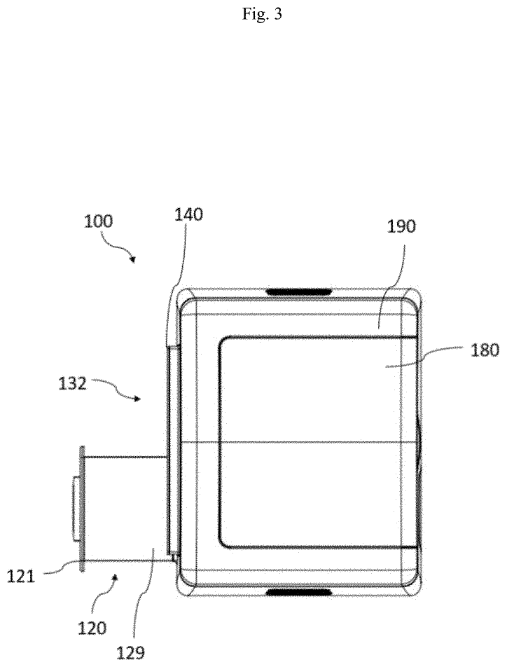

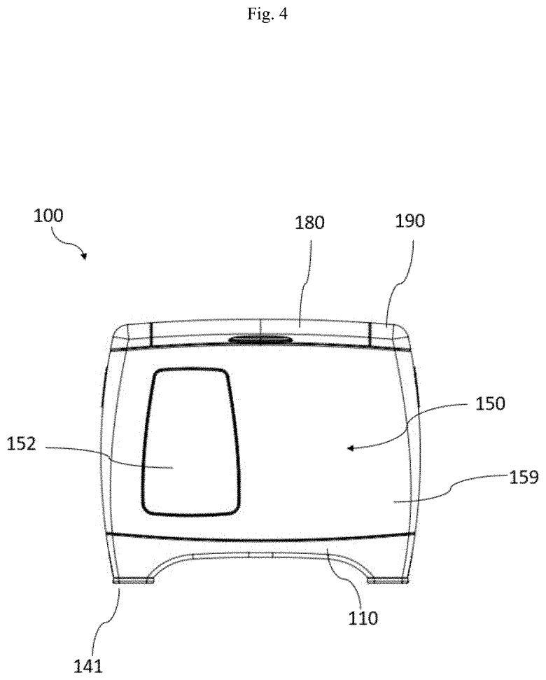

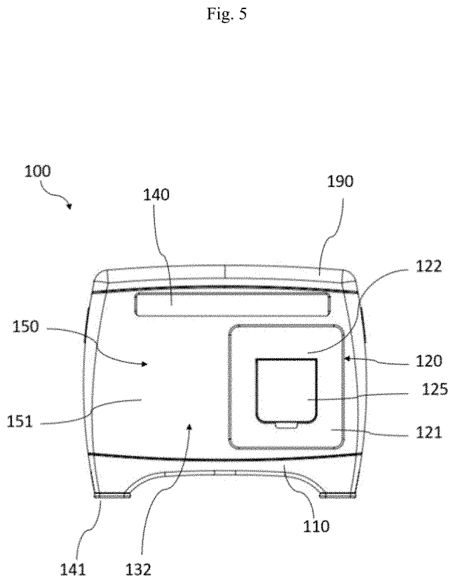

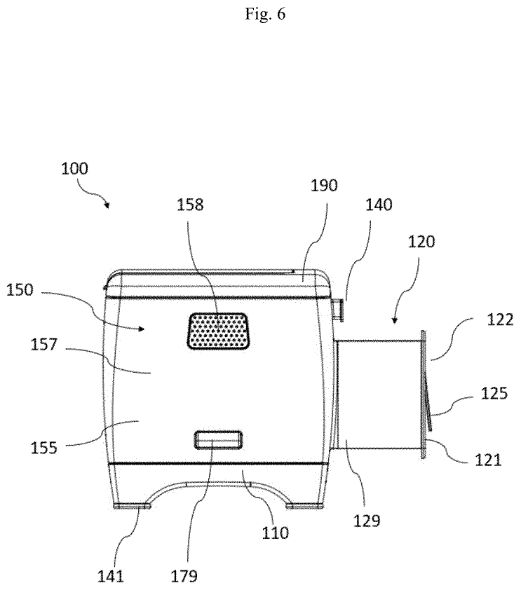

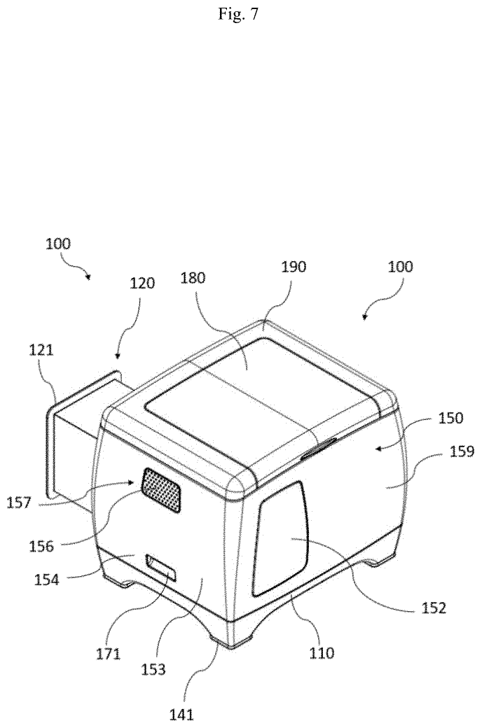

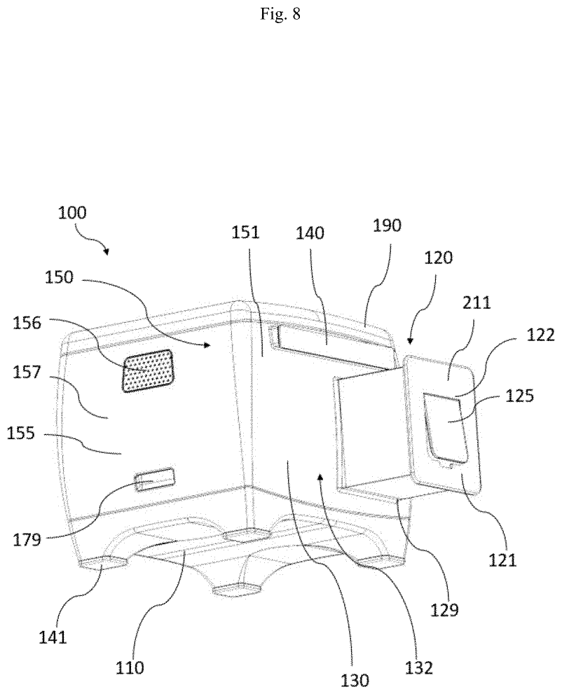

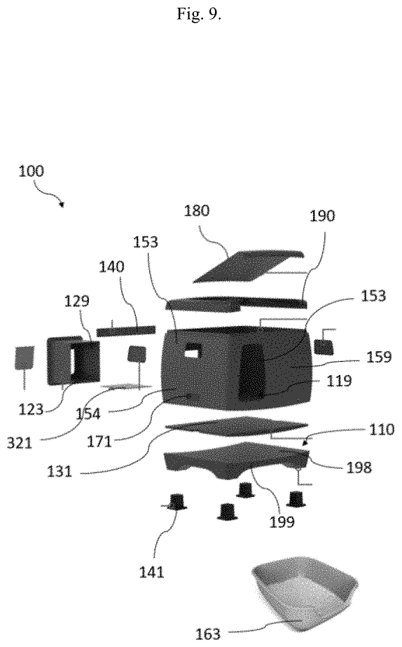

Referring to the figures, FIGS. 1-9 illustrate one example embodiment of an inventive pet litter box system 10, which is not necessarily limited to cats but for purposes of simplicity box litter system 10 will reference cats as a pet. In this example embodiment, a encapsulating or encapsulated cat litter box system 10 is mountable to a wall, but can be free-standing as well, and has a housing assembly 100 designed to contain at least one house cat and allow the cat to turn about therein. The housing assembly 100 has a removable bottom portion 110, at least one rear sidewall portion 150 and a front sidewall portion 130, a bottom or floor portion 110 and a removable top portion assembly 190. In other embodiments, the housing bottom may be made permanent and not removable so as to be integrally molded as one housing unit to lower cost and simplify manufacturing. At least one lid member 180A of the top portion assembly 180 is pivotally coupled to the top portion assembly 190 designed to be in a substantially open or closed state. Assembly 100 also includes an enclosed tunnel assembly 120 that is designed as a passageway for the at least one housecat (or dog) to crawl therethrough, the enclosed tunnel assembly 120 having an open distal end 129 and an open proximal end 121 with an optional cover plate. The tunnel assembly 120 is coupled to the at least one sidewall portion 130 at the distal end 129 of the tunnel assembly 120, the tunnel assembly 120 extending from and defining a proximal end or sidewall 130 of the housing assembly 100. The tunnel assembly 120 is designed to be disposed through the wall structure and through sidewall 130. A flap assembly 125 is pivotally coupled to a top portion 122A of the proximal end 122 of the enclosed tunnel assembly 120, the flap assembly 125 designed, when in a resting state, to substantially cover the open proximal end 121 of the enclosed tunnel assembly 120.

In this embodiment of the cat litter box 10 mountable to a wall, at least one window portion 152 is disposed within the at least one sidewall portion 150 and configured to allow viewing therethrough. At least one right vent portion 156 and at least one left vent portion 158 designed to allow air therethrough is disposed within the at least one sidewall portion 150. Housing assembly 100 optionally includes a bottom portion removable inner floor portion 131 and a tunnel assembly removable inner floor portion 132 which are planarly and respectively disposed to cover a top surface of the bottom portion of the housing assembly 198 and a top surface of a floor portion of the tunnel assembly 123.

In this example embodiment, there is optionally included a wall attachment assembly 140 that can be coupled to the proximal end of the at least one sidewall portion 150 of the proximal end of the housing assembly 130 and is designed to removably coupled the housing assembly 100 to the wall. One or more extendable leg assemblies 141 are coupled to the removable bottom portion of the housing assembly 110. The at least one right-side handle member 171 and at least one left-side handle member 179 are disposed on an exterior portion of the at least one sidewall portion 150 and are designed for lifting the housing assembly 100. The enclosed tunnel assembly 120 is detachable from the housing assembly 100.

The example embodiment illustrated in FIGS. 1-9 further illustrate the housing assembly 100 having the removable bottom portion 110, a front sidewall portion 151, a back sidewall portion 159, a right-side sidewall portion 154, a left-side sidewall portion 156, and a removable top portion assembly 190. The enclosed tunnel assembly 120 is designed for the at least one housecat to crawl therethrough, the enclosed tunnel assembly 120 removably coupled to a front side of the housing assembly 100 and offset to one side of the housing assembly 100, the tunnel assembly 120 having an open distal end 129 and an open proximal end 121, the tunnel assembly 120 coupled to the at least one sidewall portion by the distal end of the tunnel assembly 129, the tunnel assembly 120 extending from the at least one sidewall portion 150 and defining a proximal end of the housing assembly 130 on the front side of the housing assembly 132, the tunnel assembly 120 designed to be disposed through the wall structure. A removable tray member 163 is disposed within the housing assembly 100 designed to contain a cat litter material therein.

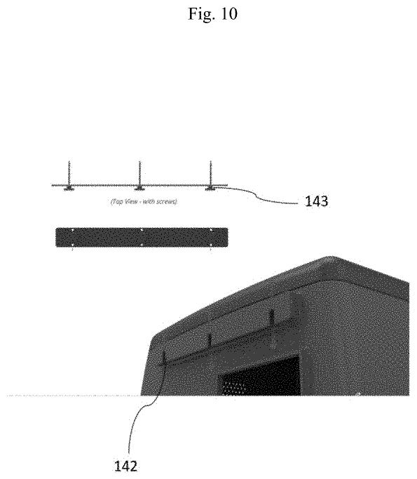

The example embodiment illustrated in FIGS. 1-9 further illustrate that a window portion 152 is disposed on the back side of the housing assembly 159 and is configured to allow viewing therethrough. The at least one left side vent portion 158 is disposed on the left sidewall portion of the housing assembly 155 and the least one right side vent portion 156 is disposed on the right sidewall portion of the housing assembly 154 and are each designed to allow air therethrough. In the illustrated embodiment, and with reference to FIG. 10, the wall attachment assembly 140 has at least two inverted-U-shaped attachment points 142 designed to removably couple the housing assembly 100 to a corresponding at least two anchor points 143 at least partially imbedded in the wall.

In this example embodiment, four or more extendable leg assemblies 141 are coupled to the removable bottom portion of the housing assembly 110. A top surface of the removable bottom portion 198 of the housing assembly 100 is at least partially concave with inward slopes connecting substantially at the respective centers. A right-side handle member 171 and a left-side handle member 179 are respectively disposed on an exterior portion of the right sidewall portion 153 and an exterior portion of the left sidewall portion 157 substantially flush to and inward from the right and left sidewall portions 154, 155 and designed for lifting the housing assembly 100 by inserting the fingers of a carrier's hands therein.

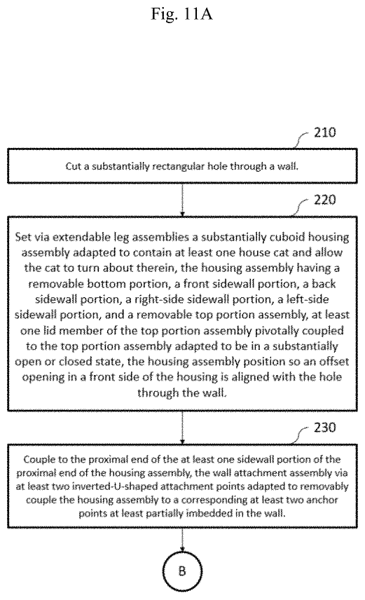

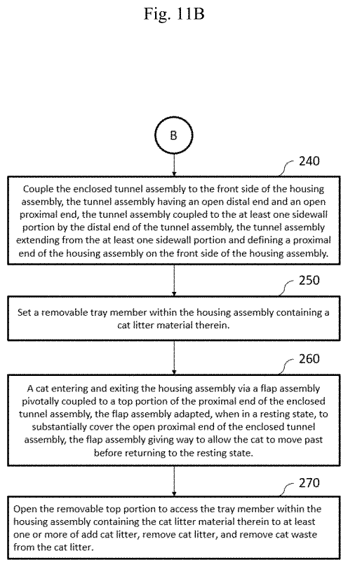

FIGS. 11A-11B illustrate a method for installing an encapsulating a pet or cat litter box mountable to a wall. The method includes the step of 210 cutting a substantially rectangular hole through a wall. The method further includes the step of 220 setting via extendable leg assemblies 141 the substantially cuboid housing assembly 100 designed to contain at least one house cat and allow the cat to turn about therein, the housing assembly 100 having the removable bottom portion 110, the front sidewall portion 151, the back sidewall portion 159, the right-side sidewall portion 154, the left-side sidewall portion 155, and the removable top portion assembly 190, the at least one lid member of the top portion assembly 180 pivotally coupled to the top portion assembly 190 designed to be in a substantially open or closed state, the housing assembly 100 position so the offset opening in the front side of the housing 132 is aligned with the hole through the wall. The method further includes the step of 230 coupling the proximal end of the housing assembly 130 to the wall attachment assembly via at least two inverted-U-shaped attachment points 142 designed to removably couple the housing assembly to the corresponding at least two anchor points 143 at least partially imbedded in the wall.

The method further includes the step of 240 inserting the enclosed tunnel assembly 120 substantially through the hole through the wall on the side of the wall opposite the housing assembly 100, the enclosed tunnel assembly 120 designed to allow the at least one housecat to crawl therethrough. The method further includes the step of 250 removably coupling the enclosed tunnel assembly 120 to the front side of the housing assembly 132, the tunnel assembly 120 having the open distal end 129 and the open proximal end 121, the tunnel assembly 120 coupled to the at least one sidewall portion 150 by the distal end of the tunnel assembly 129, the tunnel assembly 120 extending from the at least one sidewall portion 150 and defining the proximal end of the housing assembly 130 on the front side of the housing assembly 132. The method further includes the step of 260 setting the removable tray member 163 within the housing assembly 100 containing the cat litter material therein.

FIGS. 11A-11B further illustrate that the method for installing an encapsulating a cat litter box mountable to a wall may include 270 a cat entering and exiting the housing assembly 100 via the flap assembly 125 pivotally coupled to the top portion of the proximal end of the enclosed tunnel assembly 122, the flap assembly 125 designed, when in a resting state, to substantially cover the open proximal end of the enclosed tunnel assembly 121, the flap assembly 125 giving way to allow the cat to move past before returning to the resting state.

FIGS. 11A-11B further illustrate that the method for installing an encapsulating a cat litter box mountable to a wall may include opening the removable top portion 190 to access the removable tray member 163 within the housing assembly 100 containing the cat litter material therein to at least one or more of add cat litter, remove cat litter, and remove cat waste from the cat litter.

The following patents are incorporated by reference in their entireties: U.S. Pat. Nos. 20160374306, 4,505,226, 4,870,924, 5,931,119, 7,380,519, 4,696,257, 4,616,598, 5,564,364, 5,845,601, 6,401,661, 5,018,482, 5,134,972, 5,752,465, 5,511,513, and 20090205578.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An encapsulated pet litter box mountable to a wall comprising:
a housing assembly adapted to receive or contain at least one pet and dimensionally large enough to allow a pet to turn about therein, the housing assembly having a removable bottom portion, at least a front and a rear sidewall portion, and a removable top portion assembly, at least one lid member of the top portion assembly pivotally coupled to the top portion assembly adapted to open or close with pet entry and exit;
an enclosed tunnel assembly disposed on and extending partially through the housing assembly and adapted to receive or contain at least one pet and dimensionally large enough to allow the pet to crawl therethrough, the enclosed tunnel assembly having an open distal end and an open proximal end, the distal end of the tunnel assembly coupled to and extending from the at least one sidewall portion of the housing assembly; and
a flap assembly pivotally coupled to a top portion of the proximal end of the enclosed tunnel assembly, the flap assembly adapted, when in a resting state, to substantially cover the open proximal end of the enclosed tunnel assembly.

2. The encapsulated pet litter box mountable to a wall of claim 1 wherein at least one window portion is disposed within the at least one sidewall portion and configured to allow viewing therethrough.

3. The encapsulated pet litter box mountable to a wall of claim 1 wherein at least one vent portion adapted to allow air therethrough is disposed within the at least one sidewall portion.

4. The encapsulated pet litter box mountable to a wall of claim 1 wherein a bottom portion of the housing assembly includes a removable inner floor portion and a tunnel assembly removable inner floor portion that are planarly and respectively disposed to cover a top surface of the bottom portion of the housing assembly and a top surface of a floor portion of the tunnel assembly.

5. The encapsulated pet litter box mountable to a wall of claim 1 wherein a wall attachment assembly for the housing assembly is coupled to the proximal end of the housing assembly, wherein the wall attachment assembly is adapted to allow the housing assembly to be removably coupled to the wall.

6. The encapsulated pet litter box mountable to a wall of claim 1 wherein the housing assembly includes at least one or more extendable leg assemblies which are coupled to the removable bottom portion of the housing assembly.

7. The encapsulated pet litter box mountable to a wall of claim 1 wherein at least one right-side handle member and at least one left-side handle member are disposed on an exterior portion of the at least one sidewall portion, the handle members adapted for lifting the housing assembly.

8. The encapsulated pet litter box mountable to a wall of claim 1 wherein the enclosed tunnel assembly is detachable from the housing assembly.

9. An encapsulated cat litter box mountable to a wall comprising:
a substantially cuboid housing assembly adapted to contain at least one cat and allow the cat to turn about therein, the housing assembly having a removable bottom portion, four sidewall portions, and a removable top portion assembly, at least one lid member of the top portion assembly pivotally coupled to the top portion assembly adapted to be in a substantially open or closed state;
an enclosed tunnel assembly adapted for the at least one housecat to crawl therethrough, the enclosed tunnel assembly removably coupled to a front side of the housing assembly and offset to one side of the housing assembly, the tunnel assembly having an open distal end and an open proximal end, the tunnel assembly coupled to the at least one sidewall portion by the distal end of the tunnel assembly, the tunnel assembly extending from the at least one sidewall portion and defining a proximal end of the housing assembly on the front side of the housing assembly, the tunnel assembly adapted to be disposed through the wall structure;
a removable tray member disposed within the housing assembly adapted to contain a cat litter material therein; and
a flap assembly pivotally coupled to a top portion of the proximal end of the enclosed tunnel assembly, the flap assembly adapted, when in a resting state, to substantially cover the open proximal end of the enclosed tunnel assembly.

10. The encapsulated cat litter box mountable to a wall of claim 9 wherein a window portion is disposed on the distal side end of the housing assembly on the back side of the housing assembly and configured to allow viewing therethrough.

11. The encapsulated cat litter box mountable to a wall of claim 9 wherein at least one left side vent portion disposed on a left sidewall portion of the housing assembly and at least one right side vent portion disposed on a right sidewall portion of the housing assembly are each adapted to allow air therethrough.

12. The encapsulated cat litter box mountable to a wall of claim 9 wherein a bottom portion removable inner floor portion and a tunnel assembly removable inner floor portion are planarly and respectively disposed to cover a top surface of the bottom portion of the housing assembly and a top surface of a floor portion of the tunnel assembly.

13. The encapsulated cat litter box mountable to a wall of claim 9 wherein a wall attachment assembly is coupled to the proximal end of the at least one sidewall portion of the proximal end of the housing assembly, the wall attachment assembly having at least two inverted-U-shaped attachment points adapted to removably couple the housing assembly to a corresponding at least two anchor points at least partially imbedded in the wall.

14. The encapsulated cat litter box mountable to a wall of claim 9 wherein four or more extendable leg assemblies are coupled to the removable bottom portion of the housing assembly.

15. The encapsulated cat litter box mountable to a wall of claim 14 wherein a top surface of the removable bottom portion of the housing assembly is at least partially concave with inward slopes connecting substantially at the respective centers.

16. The encapsulated cat litter box mountable to a wall of claim 9 wherein a right-side handle member and a left-side handle member are respectively disposed on an exterior portion of the right and left sidewall portions substantially flush to and inward from the sidewall portions and adapted for lifting the housing assembly by inserting the fingers of a carrier's hands therein.

17. The encapsulated cat litter box mountable to a wall of claim 9 wherein the enclosed tunnel assembly is detachable from the housing assembly.

18. A method for installing an encapsulating a pet litter box mountable to a wall, the method comprising the steps of:
cutting a hole through a wall;
setting via extendable leg assemblies a substantially cuboid housing assembly adapted to contain at least one house cat and allow the cat to turn about therein, the housing assembly having a removable bottom portion, four sidewall portions, and a removable top portion assembly, at least one lid member of the top portion assembly pivotally coupled to the top portion assembly adapted to be in a substantially open or closed state, the housing assembly positioned so an offset opening in a front side of the housing is aligned with the hole through the wall;
coupling the proximal end of the housing assembly to the wall attachment assembly via at least two inverted-U-shaped attachment points adapted to removably couple the housing assembly to a corresponding at least two anchor points at least partially imbedded in the wall;
inserting an enclosed tunnel assembly substantially through the hole through the wall on a side of the wall opposite the housing assembly, the enclosed tunnel assembly adapted to allow the at least one cat to crawl therethrough;
removably coupling the enclosed tunnel to the front side of the housing assembly, the tunnel assembly having an open distal end and an open proximal end, the tunnel assembly coupled to the at least one sidewall portion by the distal end of the tunnel assembly, the tunnel assembly extending from the at least one sidewall portion and defining a proximal end of the housing assembly on the front side of the housing assembly; and
setting a removable tray member within the housing assembly containing a cat litter material therein.

19. The method for installing an encapsulating a cat litter box mountable to a wall of claim 18, the method further including installing a flap assembly pivotally coupled to a top portion of the proximal end of the enclosed tunnel assembly, the flap assembly adapted, when in a resting state, to substantially cover the open proximal end of the enclosed tunnel assembly, the flap assembly giving way to allow a cat to move past before returning to the resting state.

20. The method for installing an encapsulating a cat litter box mountable to a wall of claim 18, the method further including the step of incorporating an opening the removable top portion to access the removable tray member within the housing assembly containing the cat litter material therein to at least one or more of add cat litter, remove cat litter, and remove cat waste from the cat litter.
